(19) United States
(12) Patent Application Publication
(10) Pub. No.: US 2026/0192676 A1
(43) Pub. Date: Jul. 9, 2026

(54) Electrical Contacting Device for an Electrical Energy Store of an at Least Partially Electrically Operated Motor Vehicle, Electrical Energy Storage Device and Motor Vehicle

(71) Applicant: Bayerische Motoren Werke Aktiengesellschaft, Muenchen (DE)

(72) Inventors: Wolfgang OBLINGER, Ingolstadt (DE); Florian SOLDNER, Brannenburg (DE)

(21) Appl. No.: 19/129,351

(22) PCT Filed: Oct. 18, 2023
(86) PCT No.: PCT/EP2023/078918

§ 371 Date: May 13, 2025

(30) Foreign Application Priority Data
Nov. 14, 2022 (DE) 10 2022 130 031.5

(51) Int. Cl. B60L 3/04; B60K 1/04; H01M 50/503; H01M 50/583

(52) U.S. Cl. CPC B60L 3/04; B60K 1/04; H01M 50/503; H01M 50/583; B60K 2001/0438; H01M 2200/103; H01M 2220/20

(57) ABSTRACT

An electrical contacting device for an electrical energy storage device of an at least partially electrically powered motor vehicle includes at least one contact element for contacting a pole of the electrical energy storage device and a fixing element for fixing the contact element to the pole. The contact element is contacted with the pole via the fixing element under a preload force. The electrical contacting device has a pyrotechnical device which is designed to release the fixing element when a control signal is received.

### BACKGROUND AND SUMMARY

The invention relates to an electrical contacting device for an electrical energy store of an at least partially electrically operated motor vehicle. Further, the invention relates to an electrical energy store and to a motor vehicle.

Pyrotechnic fuses, which are positioned, for example, on printed circuit boards of an electronic system, are already known from the prior art. Furthermore, electrical fuses in a cell contacting system and fuses on printed circuit boards are correspondingly known.

However, pyrofuses are difficult to position on the circuit board layout due to their space requirement, the local proximity to the high-voltage tap and the maintenance of corresponding safety zones, in particular outside the intrusion zone. Corresponding electrical fuses in the cell contacting system as fuses cannot be triggered in a controlled manner by a crash, although locally directly on the high-voltage system, but as a rule are not service-able. Furthermore, fuses on the printed circuit board can have all the negative properties of the above solutions.

DE 10 2015 222 664 A1 discloses a safety device for a vehicle, in particular a motor vehicle, comprising an axle carrier, a load path expansion element which is connected to the axle carrier, and a component of the vehicle, which component is different from the load path expansion element and is connected to the load path expansion element, wherein the load path expansion element has a projecting portion which is configured to absorb an impact force which occurs by the frontal impact during intended use, in the event of a frontal impact of the vehicle with the obstacle, and which is opposite to that, the axle carrier projects transversely to a vehicle longitudinal direction in the direction of a lateral vehicle outer edge which is obvious with respect to the obstacle, and the safety device is configured in such a way that part of the absorbed impact force is guided into the axle carrier, and another part of the absorbed impact force is guided into the component of the vehicle.

EP 2 143 962 A1 relates to a connecting device arranged in a motor vehicle for detachably connecting a component of the vehicle to the vehicle chassis, wherein the connecting device comprises a bolt connection system. The connecting device further comprises a pyrotechnic charge and an igniter, wherein the igniter is configured to, when receiving an ignition signal, bring the pyrotechnic charge to detonation, wherein the pyrotechnic charge is disposed proximate to the bolt connection system such that, in the detonation, the connection function of the bolt connection system is destroyed to release the structural element from the chassis.

The object of this invention is to provide an electrical contacting device, an electrical energy store and a motor vehicle, by means of which a safer operation of the motor vehicle is made possible.

This object is achieved by an electrical contacting device, an electrical energy store and by a motor vehicle according to the independent patent claims. Advantageous embodiments are specified in the dependent claims.

One aspect of the invention relates to an electrical contacting device for an electrical energy store of an at least partially electrically operated motor vehicle, having at least one contact element for contacting a pole of the electrical energy store, in order to be connected to a fixing element for fixing the contact element to the pole.

It is envisaged that the contact element is contacted with the pole via the fixing element under a prestressing force, and the electrical contacting device has a pyrotechnic device which is designed to release the fixing element when a control signal is received.

In particular, it is thus proposed that the electrical contact device be arranged directly on the high-voltage interface of the electrical energy store. All voltage-carrying high-voltage interfaces of the motor vehicle can then be separated from the energy storage system on the basis of a qualified crash signal.

In particular, a pyrotechnically releasable screw connection is provided at the high-voltage storage tap. By screwing the high-voltage connection, which is designed, for example, as a spring element with prestress, a separation of the connector is achieved when the screw head is broken off with immediate action. Alternatively, the bolt itself can also be partially broken off in segments while maintaining the air and creepage distances. A significantly lower footprint is advantageous in comparison with the previous solutions. A significantly lower z-construction height, in particular decisively in the case of a pole and side crash load cases, and the direct decoupling at the energy storage system without further residual conductors, must be taken into account. In the ideal case, the so-called positive poles and negative poles, in particular also the individual poles in switching batteries, are simultaneously separated and thus an external insulation fault is avoided. The system can be serviceable or repaired by inserting a new screw.

According to an advantageous embodiment, the contact element is designed in a spring-like manner. In particular, the contact element is relaxed in the non-intended state and is only tensioned by the fixing element and attached to the pole. Thus, a mechanical prestressing force can be generated which, after removal of the fixing element, in turn brings the contact element into a position in which no electrical contact with the pole is to be recorded. Thus, by simply releasing the fixing element, the spring-like contact element can be brought into a zero position, in which a mechanical stress relief is produced.

A further advantageous embodiment provides that the fixing element is helical and the pyrotechnic device is designed to release a screw head of the fixing element. In particular, the screw head is thus blown off by means of the pyrotechnic device and the fixing element in turn releases the prestressing force, so that the contact element can be brought into a zero position in which no contacting of the pole is to be realized. In particular, in the installed state and in the intended state, the contact element is thus in a use position under prestress on the pole and is electrically contacted therewith, and when the fixing element is removed or released, the contact element is brought into a zero position, in which no prestressing force is to be drawn, and the electrical contacting is interrupted.

Furthermore, it has proven advantageous if the control signal is generated when an accident of the motor vehicle is detected. Furthermore, corresponding pre-crash sensors can also be installed, which also already generate the control signal before an accident of the motor vehicle and thus cause a voltage release of the electrical energy store even before the accident.

It is also advantageous if the electrical contacting device additionally has an electrical securing element between the pole and the contact element. In this case, the electrical fuse element can preferably be designed as a fusible link. This can in particular prevent a corresponding arc from being drawn between the contact element and the pole when the electrical contacting is released. When the contact element is opened or the contact element is released from the pole, the voltage is then again dissipated via the electrical fuse element, which leads to the melting of the fuse, as a result of which the arc only spreads within the fuse and thus prevents an arc to be located outside the securing element.

A further aspect of the invention relates to an electrical energy store for an at least partially electrically operated motor vehicle having at least one electrical contacting device according to the preceding aspect.

An advantageous embodiment provides that the electrical energy store has a respective electrical contacting device at a respective pole.

Furthermore, it can advantageously also be envisaged that the control signal is generated in such a way that the electrical contacting device simultaneously triggers. External insulation faults can thus be avoided.

A still further aspect of the invention relates to a motor vehicle having an electrical energy store according to the preceding aspect. The motor vehicle can be designed as an at least partially electrically operated motor vehicle, in particular as a fully electrically operated motor vehicle.

Advantageous embodiments of the electrical contacting device are to be regarded as advantageous embodiments of the electrical energy store and of the motor vehicle.

Further features of the invention emerge from the claims, the figures and the description of the figures. The features and combinations of features mentioned above in the description and the features and combinations of features mentioned below in the description of the figures and/or shown alone in the figures can be used not only in the respectively specified combination, but also in other combinations or alone.

The invention will now be explained in more detail with reference to a preferred embodiment and with reference to the drawings.

### BRIEF DESCRIPTION OF THE DRAWINGS

FIG. 1 is a schematic side view of an embodiment of a motor vehicle with an embodiment of an electrical energy store; and

FIG. 2 is a schematic perspective view of an embodiment of an electrical energy store with an embodiment of an electrical contacting device.

In the figures, identical or functionally identical elements are provided with the same reference signs.

### DETAILED DESCRIPTION OF THE DRAWINGS

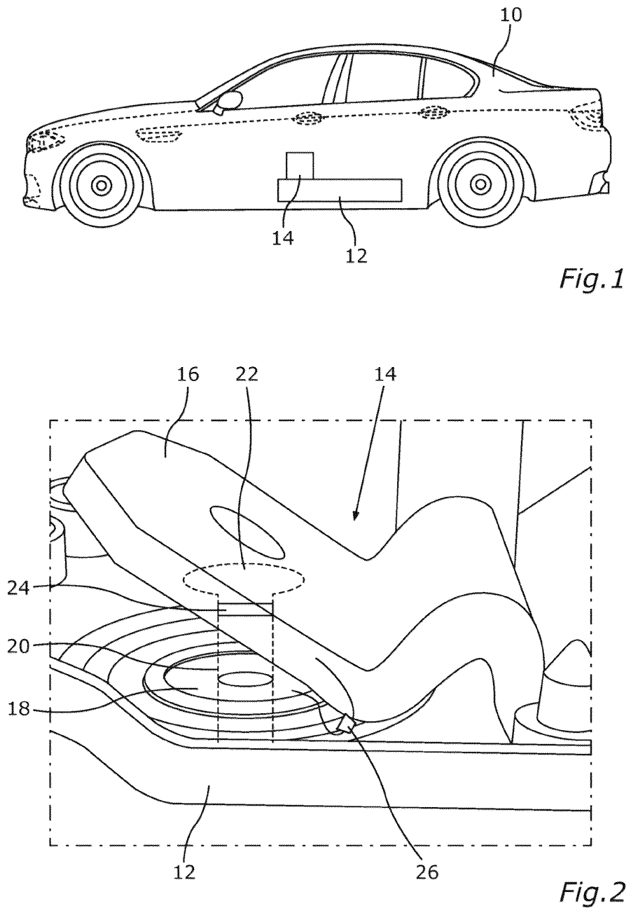

FIG. 1 shows, in a schematic side view, an embodiment of a motor vehicle 10. The motor vehicle 10 is designed in particular as an at least partially electrically operated motor vehicle or fully electrically operated motor vehicle. For this purpose, the motor vehicle 10 has an electrical energy store 12, which is designed in particular in the manner of a traction battery. The electrical energy store 12 is in particular also designed as a high-voltage accumulator. The electrical energy store 12 in turn has an electrical contacting device 14, by means of which, for example, further functional parts within the motor vehicle 10, for example a drive train, can be contacted with the electrical energy store.

FIG. 2 shows a perspective view of an embodiment of the electrical energy store 12. In particular, the electrical contacting device 14 is shown enlarged. The electrical contacting device 14 has at least one contact element 16 for contacting a pole 18 of the electrical energy store 12. Furthermore, a fixing element 20 is shown in dashed lines, since this is not introduced in the present form. For electrical contacting of the contact element 16 with the pole 18, however, the fixing element is screwed to the pole 18 via the contact element 16, for example, and in particular the prestressed contact element 16 is held in a position of use on the pole 18 with the fixing element 20, in particular with a screw head 22. FIG. 2 thus shows the contact element 16 in a non-use position/zero position. In this position, in particular, no electrical contact is to be drawn between the pole 18 and the contact element 16.

According to the invention, the contact element 18 is contacted with the pole 18 via the fixing element 20 under a prestressing force, and the electrical contacting device has a pyrotechnic device 24 which is designed to release the fixing element 20, for example the screw head 22, from the fixing element 20 when a control signal is received, so that the contact element 16 can bring the contact element 16 out of the contact position, in other words a use position into the zero position, as is now shown in FIG. 2. In the following exemplary embodiment, the pyrotechnic device 24 is formed on the fixing element 20 itself. This is purely exemplary. Further arrangements, for example in the vicinity of the pole or on the contact element 16, can also be provided.

As FIG. 2 shows, the contact element 16 is designed in particular in a spring-like manner. In the following exemplary embodiment, the contact element 16 is designed in particular in the manner of a leaf spring. Other embodiments are also possible.

Furthermore, the electrical contacting device 14 additionally has an electrical fuse element 26, in particular in the form of a fuse, so that when the screw head 22 is broken off, an arc is prevented between the pole 18 and the contact element 16, since the voltage or current is dissipated via the securing element 26, wherein the fuse then in turn correspondingly melts and does not produce an arc, in particular outside the securing element 26. Overall, the pyrotechnically releasable screw connection is thus provided at the high-voltage storage tap. By screwing the high-voltage connection, which is designed, for example, as a spring element with prestress, a separation of the connector is achieved when the screw head 22 breaks off with immediate action. Alternatively, the bolt itself can also be partially broken off in segments while maintaining the air and creepage distances. Advantageously, the lower footprint is significantly lower compared to the previous solution. A significantly lower z-body height and the direct decoupling at the energy storage system m without further residual conductors. In the ideal case, all the poles and also corresponding poles of switching batteries are simultaneously separated and thus an external insulation fault can be avoided. By inserting a new screw, the system is then serviceable or repairable.

### LIST OF REFERENCE NUMBERS

10 Motor vehicle
12 Electrical Energy Store
14 Electrical Contacting Device
16 Contact element
18 Pole
20 Fixing element
22 Screw head
24 Pyrotechnic device
26 Securing element

1-10. (canceled)

11. An electrical contacting device for an electrical energy store of an at least partially electrically operated motor vehicle, comprising:
at least one contact element for contacting a pole of the electrical energy store;
a fixing element for fixing the contact element to the pole;
wherein the contact element is contacted with the pole via the fixing element under a prestressing force; and
a pyrotechnic device configured to release the fixing element when a control signal is received.

12. The electrical contacting device according to claim 11, wherein
the contact element is configured in a spring-type manner.

13. The electrical contacting device according to claim 11, wherein
the fixing element is helical, and
the pyrotechnic device is configured to release a screw head of the fixing element.

14. The electrical contacting device according to claim 11, wherein,
when an accident of the motor vehicle is detected, the control signal is generated.

15. The electrical contacting device according to claim 11, further comprising:
an electrical safety element arranged between the pole and the contact element.

16. The electrical contacting device according to claim 15, wherein the electrical safety element is configured as a fuse.

17. An electrical energy store for an at least partially electrically operated motor vehicle comprising at least one electrical contacting device according to claim 11.

18. The electrical energy store according to claim 17, wherein the electrical energy store has a respective electrical contacting device at a respective pole.

19. The electrical energy store according to claim 18, wherein the control signal is generated such that the electrical contacting device triggers simultaneously.

20. A motor vehicle comprising an electrical energy store according to claim 17.
